(19) United States
(12) Patent Application Publication
(10) Pub. No.: US 2025/0291593 A1
(43) Pub. Date: Sep. 18, 2025

(54) METHOD FOR PERFORMING A FORK OPERATION ON A MULTITHREADED APPLICATION TO SUPPORT IN-MEMORY CHECKPOINTING

(71) Applicant: Arm Limited, Cambridge (GB)

(72) Inventors: Johannes Overmann, Gundelfingen (DE); Lingxiao Jia, Austin, TX (US)

(21) Appl. No.: 18/603,557

(22) Filed: Mar. 13, 2024

(51) Int. Cl. G06F 9/30; G06F 9/38

(52) U.S. Cl. CPC G06F 9/3009; G06F 9/3861

(57) ABSTRACT

A method for performing a fork operation on a multithreaded application includes executing a component-based code including a set of instructions comprising multiple threads. The method further includes receiving a request from a controlling process to perform a fork operation on the component-based code at an instruction within the component-based code and directing the fork operation on the component-based code. The method further includes causing the component-based code to execute only one primary thread of the multiple threads by stopping execution of the other multiple threads, duplicating the component-based code at the instruction to create a child process comprising a copy of the primary thread, restarting execution of the other multiple threads in the component-based code, performing a correction of the child process, and creating multiple threads of the child process. The multiple threads of the child process mirror the multiple threads of the component-based code.

### BACKGROUND

When executing computer programs, it is sometimes desirable to be able to resume from a previously saved state after making changes to the computer program which are not easily undone. In-memory checkpointing allows a user to snapshot a memory image of a running computer program to main memory so that the user can return to a previous execution state of the program using the memory image.

In order to create the memory image while the program is running (e.g., so that the program is not suspended while the snapshot is being copied and slows down program execution), a fork operation can be used to create the memory image. In computing, a process being executed in the program, also known as the parent process, can utilize a fork function, e.g., fork( ) to create a copy of itself, e.g., a child process, that includes state information at the point at which the fork function is called. In this way, the parent process represents the memory image while the child process continues executing. However, the fork function only works well on single threaded programs. Multithreaded programs include multiple threads of execution, each thread executing independently and concurrently, while sharing process resources. The multiple threads include synchronization points or known points in each thread's flow of execution where that thread will wait for the other threads before continuing. Unfortunately, the fork function does not work well with multithreaded programs because only the thread calling the fork operation is duplicated; the other threads are not present in the child process. In addition, all thread synchronization points are left in whatever state they were at the time of the fork operation.

### BRIEF SUMMARY

A method that performs a fork operation in a multithreaded program is provided. Using the method described herein, in-memory checkpointing can be achieved using an operating system fork function call on a component-based code comprising multiple threads.

A computer implemented method is provided. The computer implemented method includes the steps of executing a component-based code including a set of instructions comprising multiple threads. At least one component of the component-based code maintains one or more of the multiple threads. The component-based code is controlled by a controlling process on a computing system. The computer implemented method further includes receiving a request from the controlling process to perform a fork operation on the component-based code at an instruction within the component-based code and directing the fork operation on the component-based code. Directing the fork operation on the component-based code at the instruction is accomplished by causing the component-based code to execute only one primary thread of the multiple threads by stopping execution of the other multiple threads, duplicating the component-based code at the instruction to create a child process comprising a copy of the primary thread, restarting execution of the other multiple threads in the component-based code, performing a correction of the child process, and creating multiple threads of the child process. The multiple threads of the child process mirror the multiple threads of the component-based code.

A computer system simulator, which can be embodied as instructions stored on a computer-readable storage medium, can, when executed by a computing system, direct the computing system to execute a component-based code including a set of instructions comprising multiple threads, receive a request from a controlling process to perform a fork operation on the component-based code at an instruction within the component-based code and direct the fork operation on the component-based code. The computing system is them further directed to cause the component-based code to execute only one primary thread of the multiple threads by stopping execution of the other multiple threads, duplicate the component-based code at the instruction to create a child process comprising a copy of the primary thread, restart execution of the other multiple threads of the component-based code, perform a correction of the child process, and create multiple threads of the child process.

A computing system includes one or more processors and a memory, wherein the memory stores instructions that when executed by a computing system, direct the computing system to execute a component-based code including a set of instructions comprising multiple threads, receive a request from a controlling process to perform a fork operation on the component-based code at an instruction within the component-based code and direct the fork operation on the component-based code. The computing system is them further directed to cause the component-based code to execute only one primary thread of the multiple threads by stopping execution of the other multiple threads, duplicate the component-based code at the instruction to create a child process comprising a copy of the primary thread, restart execution of the other multiple threads of the component-based code, perform a correction of the child process, and create multiple threads of the child process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example operating environment for a system that performs in-memory checkpointing.

FIG. 2 illustrates a method for performing a fork operation in a multithreaded program.

FIG. 3 illustrates a sequence diagram to perform the fork operation on the multithreaded application.

FIG. 4 illustrates a schematic representation of the system before and after performing the fork operation in the multithreaded program.

### DETAILED DESCRIPTION

A method that performs a fork operation in a multithreaded program is provided. Using the method described herein, in-memory checkpointing can be achieved using an operating system fork function call on a component-based code comprising multiple threads.

An application process such as a simulator code can be executed by a computing (or host) system. The simulator code can include a component-based design in which the code is composed of functional or logical components that are invoked by a central scheduler. Each component is a well-defined part of the code and includes a well-defined interface. In some cases, the component-based simulator code can be multithreaded so that at least one component maintains one or more of multiple threads making up the multithreaded simulator code. In order to perform a fork operation, the method utilizes the functionality of the component-based code that allows the central scheduler to invoke process-wide function calls, e.g., callbacks, on all components.

A computer system simulator, which can be embodied as instructions stored on a computer readable storage medium, can, when executed by a computing system, simulate the execution of a guest software, e.g., the workload, on a specific processor and platform. One use of computer system simulators is for analyzing specific aspects of runtime behavior of a particular system architecture. This use of a computer system simulator is beneficial in development environments where the particular system architecture of interest is not present, for example when the actual hardware is not yet available. In addition, the use of a computer system simulator can provide information concerning the internal behavior of the simulated computer system that would not be available using the actual hardware. For example, a key sub-component in a computer system simulation is software that simulates the behavior of a physical computer processor. In such a simulator, for each machine instruction that would be executed, actions semantically comparable to the guest instructions are executed on the host processor. Thus, if one wants to simulate a particular instruction exactly in a simulator for validation purposes or for software checking, the simulator should match the numeric output of the hardware.

An in-memory checkpoint operation can be added to the simulator code and enabled when the simulator is running to perform in-memory checkpointing at certain locations within the simulator code. An example system simulator that can be utilized to perform the proposed method with in-memory checkpointing is Fast Models from Arm Limited.

A debugger is a tool used to test and identify errors in code. The debugger is itself code that is also executed by the computing (or host) system. It can be used to control the execution of the application process, e.g., the simulator code. While the controlling process is referred to herein as the debugger code and the application process as simulator code, the proposed method and system can be utilized with any controlling process and any application process being controlled by a controlling process. For example, in some cases, the controlling process can be a validation tool.

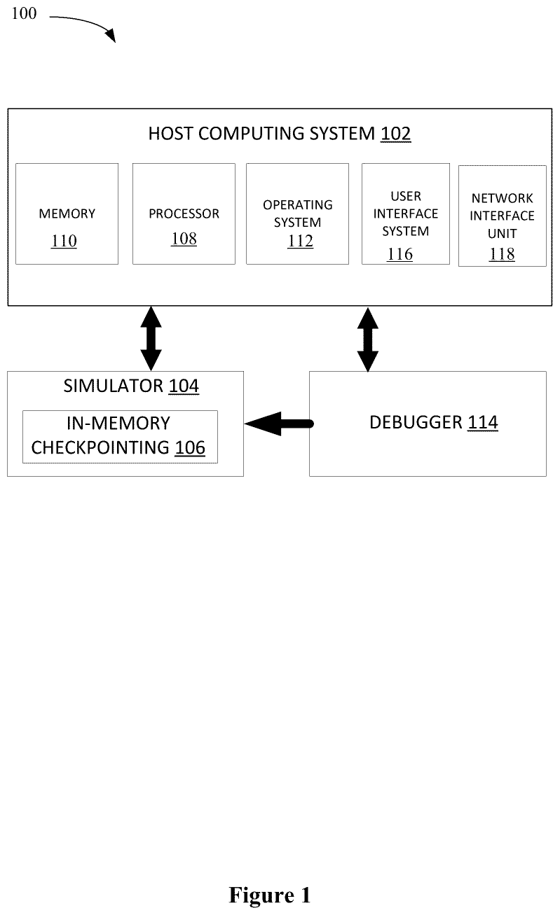

FIG. 1 illustrates an example operating environment for a system that performs in-memory checkpointing. Referring to FIG. 1, operating environment 100 includes a host computing system 102 having hardware components such as a processor 108, memory 110, operating system 112, user interface system 116, and network interface unit 118.

Although specific reference is made to a processor 108, the processor 108 can be any processing element such as, but not limited to, a CPU (central processing unit), graphics processing unit (GPU), microcontroller, or computing unit (e.g., multiplier-accumulator (MAC) unit with memory). In some cases, processor 108 can be implemented using application specific circuits (ASICs), field programmable gate arrays (FPGA), microprocessors or other hardware circuitry.

Memory 110 can include volatile and non-volatile memory hardware and include built-in (e.g., system on a chip) and removable memory hardware. Examples of volatile memory include random-access memories (RAM, DRAM, SRAM). Examples of non-volatile memory include flash memory, various read-only memories (ROM, PROM, EPROM, EEPROM), phase change memory, magnetic and ferromagnetic-ferroelectric memories (MRAM, FeRAM). Although a single memory block is shown in the drawing, it should be understood that there are different levels/hierarchy of memory and components that may be used (e.g., cache memories, processor registers, system RAM, disk drives, secondary storage, etc.).

The operating system (OS) 112 can load a program (e.g., application process, controlling process) into a memory space used by the processor 108. For example, the OS 112 can identify a next available location of appropriate size in memory 110 and load the program file of the program starting at the next available location. After the program is loaded into memory 110, the OS 112 directs the processor 108 to the memory address at which the program begins in order to begin execution of the program (as an instance of the program, which can be referred to as a process). The OS 112 can assign the process an identifier for keeping track of the process while it is running and properly responding to requests by the process for system resources. When the process ends, the OS 112 can remove the program (and other related data) from memory.

The hardware of the host computing system 102 executes binaries created for the architecture. The host computing system 102 further includes a simulator 104, which comprises a program, e.g., the application process, that runs on one or more processors 108, but fully simulates the behavior of another computing system, e.g., another processor(s), executing a guest binary. The guest binary is a code that runs on simulator 104.

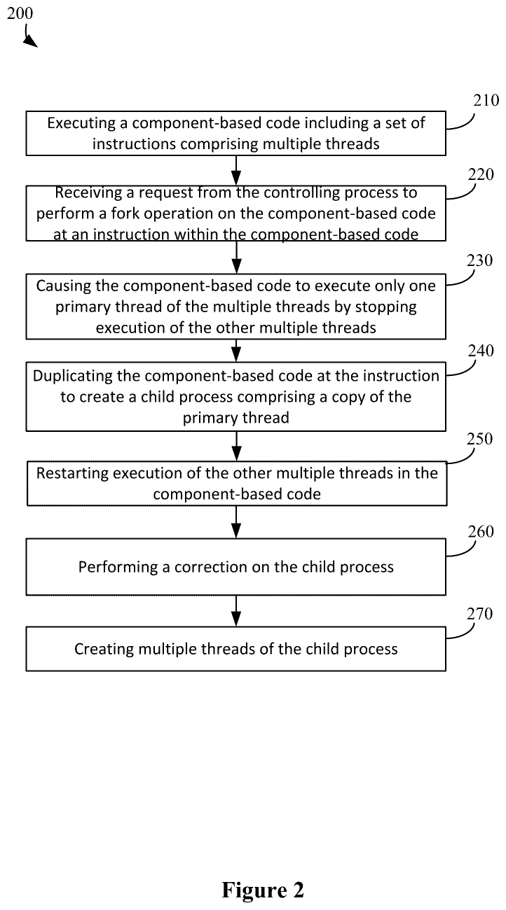

The simulator code of simulator 104 executing on the host computing system 102 can include an in-memory checkpoint feature 106 to snapshot a memory image of the entire process to main memory 110 so that the user can return to a previous execution state of the process using the memory image. The in-memory checkpoint feature 106 can include instructions as described with respect to method 200 of FIG. 2. In addition, the host machine can include a debugger 114, e.g., a controlling process, that assists a user to debug instruction execution errors in the simulator code. The debugger code also runs on host computing system 102. The controlling process, e.g., debugger code, controls the execution of the application process, e.g., the simulator code.

The host computing system 102 can further include a user interface system 116 which may include input/output (I/O) devices such as a display and components that enable communication between a user and the host computing system 102. Host computing system 102 may also include a network interface unit 118 that allows the system to communicate with other computing devices, including server computing devices and other client devices, over a network.

FIG. 2 illustrates a method for performing a fork operation in a multithreaded program. Method 200 can be performed in response to a debugging entity (e.g., a human debugger or a debugging application) requesting a fork operation to be performed via the debugger 114, for example. For example, a human debugger may hit a fork function, e.g., fork( ) button on a GUI of a display of the computing system. The request will then cause the fork operation to be performed within the application process.

Referring to FIG. 2, method 200 includes executing (210) a component-based code including a set of instructions comprising multiple threads and receiving (220) a request from the controlling process to perform a fork operation on the component-based code at an instruction within the component-based code. The method 200 further directs the fork operation on the component-based code at the instruction by causing (230) the component-based code to execute only one primary thread of the multiple threads by stopping execution of the other multiple threads, duplicating (240) the component-based code at the instruction to create a child process comprising a copy of the primary thread, restarting (250) execution of the other multiple threads in the component-based code, performing (260) a correction on the child process, and creating (270) multiple threads of the child process wherein the created multiple threads of the child process mirror the multiple threads of the component-based code.

Method 200 includes directing the fork operation on the component-based code at the instruction. In order to perform a fork operation on the component-based multithreaded code using a fork function call, the program is directed to go from multithreaded execution to single threaded execution where the fork function call is performed utilizing the single thread and then back to multithreaded execution.

Directing the fork operation on the component-based code begins by causing (230) the component-based code to execute only one primary thread of the multiple threads by stopping execution of the other multiple threads. In some cases, the primary thread is the central scheduler of the component-based code that coordinates the other components of the component-based code. The central scheduler sends a callback function to the components of the component-based code via a broadcast mechanism to stop execution of the one or more multiple threads that the at least one component maintains. In the context of this application, stopping a thread includes letting the respective thread come to an end and exit.

Method 200 further includes duplicating (240) the component-based code at the instruction to create a child process comprising a copy of the primary thread. The child process is created with a new process identifier. The duplicating (240) is performed by a fork function call of the operating system of the computing system. Then, in order to resume multithreaded execution in the component-based code, e.g., the parent process, the method further includes restarting (250) execution of the other multiple threads in the parent process. This is accomplished by the primary thread, e.g., the central scheduler, sending a callback function to all components of the component-based code to start execution of the one or more multiple threads that the at least one component maintains. At this point, the parent process can perform multithreaded execution as it was previously running prior to the fork function call.

In order to enable multithreaded execution for the child process, method 200 further includes performing (260) a correction on the child process. The correction on the child process includes recreating the synchronization points which can also be referred to as synchronization primitives. Synchronization primitives provide support for synchronization of the multiple threads and need to be established before creating the multiple threads of the child process. In some cases, synchronization primitives can include mutexes and condition variables. With the synchronization primitives recreated, the multiple threads of the child are created (270) such that execution of the multiple threads commences. Starting execution of the created multiple threads of the child process includes sending a callback function by the copy of the primary thread to all components of the child process to start execution of the created multiple threads that the at least one component maintains. So that the child process is an identical copy of the parent process, the control endpoint of the parent process is duplicated by the controlling process to create a control endpoint for the child process.

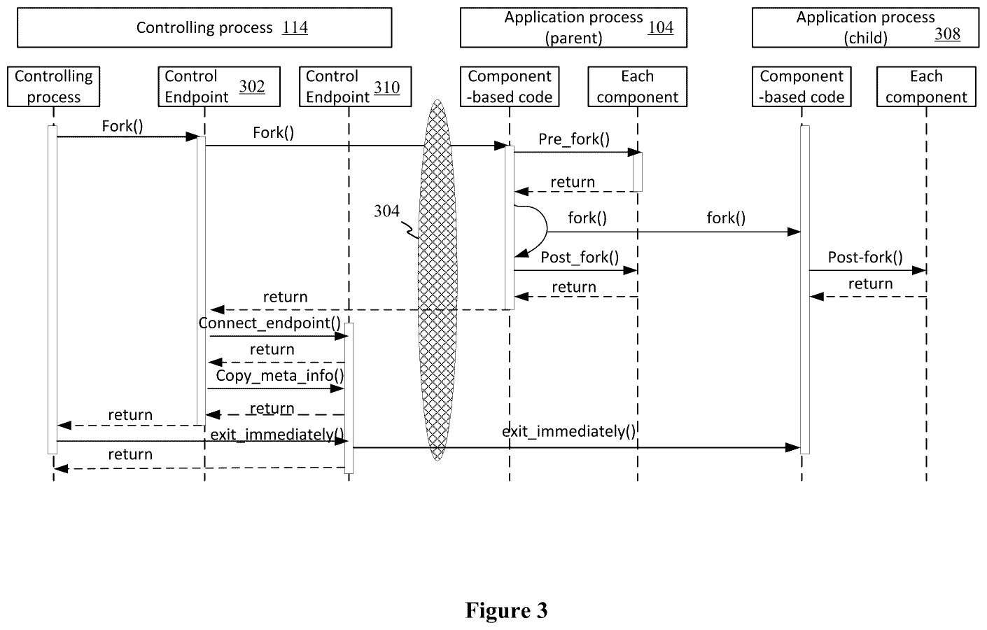

FIG. 3 illustrates a sequence diagram to perform the fork operation on the multithreaded application. The sequence diagram details operational commands between the controlling process 114 and the application process(es) 104, 308. In FIG. 3, the controlling process 114 and the application process 104 (parent process) are both executing their respective code. Application process 104 is executing (210) a component-based code including a set of instructions comprising multiple threads. Controlling process 114 communicates to application process 104 through a control endpoint 302 that serves as an endpoint for sending and receiving data across an inter-process connection 304, e.g., a network. In some cases, the control endpoint, as described herein, can be a TCP (transmission control protocol) socket or a UNIX domain socket.

Controlling process 114 requests a fork operation, shown as Fork( ) to be performed by the application process 104 via control endpoint 302. The component-based code of the parent process receives (220) the request from the controlling process 114 to perform the fork operation at the current executing instruction. The central scheduler of the component-based code sends a Pre-fork( ) call, e.g., the first callback function, to all of the components of the component-based code. The at least one component stops the one or more multiple threads it maintains prior to the return of the first callback function.

The fork( ) function is called by the component-based code and creates application process 308, e.g., child process, comprising a copy of the primary thread of the parent process. The central scheduler of the component-based code sends a Post-fork( ) call, the second callback function, to all of the components of the component-based (parent process). The at least one component of the component-based code starts the one or more threads it maintains before the return of the second callback function. Similarly, for the child process, the copy of the central scheduler, e.g., the copy of the primary thread, sends a Post-fork( ) call, the third callback function, to all of the components of the child process.

The controlling process 114 creates the control endpoint 310 for the child process by a connect_endpoint( ) call. Additionally, controlling process 114 issues a copy_meta_info( ) call to duplicate the meta-information of control endpoint 302 to the newly created control endpoint 310 of the child process. The meta information can include names of the components of the component-based code along with attributes of the components. Attribute data can include release dates and version information. Attribute information can also include register data and memory data include the memory type. At this point, control endpoint 310 is a copy of control endpoint 302 and the controlling process 114 can utilize both control endpoints once the connect_endpoint( ) returns. In some cases, the controlling process may want to terminate the child process in order to free resources of the operating system 112 of the host computing system 102. This can be accomplished with an exit_immediately( ) call from the controlling process 114 to the application process 308 via control endpoint 310. Once the child process 308 receives this command, it terminates and is deleted from memory. In some cases, the child process is terminated without executing a standard shutdown sequence in order to quickly free the resources of the child process.

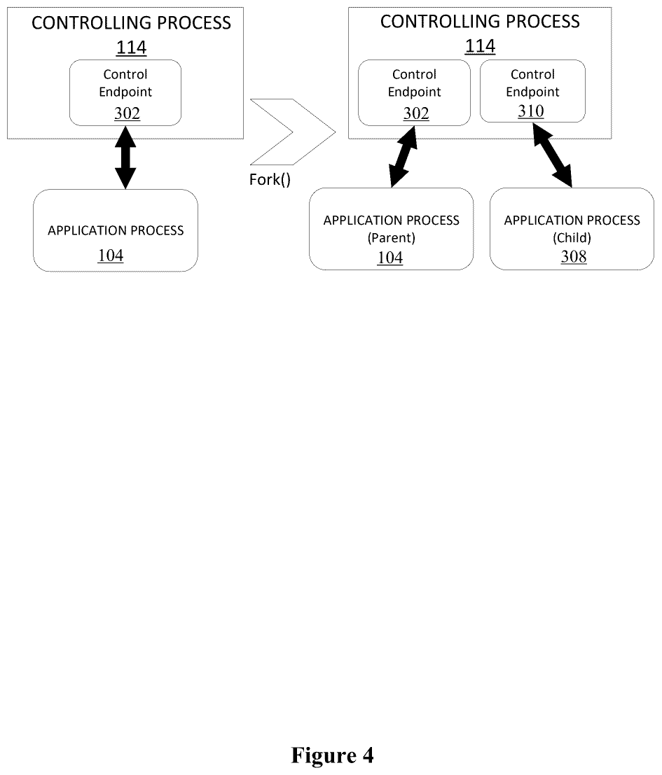

FIG. 4 illustrates a schematic representation of the component-based application process before and after performing the fork operation in the multithreaded program. Starting from the left side of FIG. 4, prior to performing a fork operation according to method 200 as described previously, an application process, e.g., simulator code 104, controlled by a controlling process, e.g., debugger code 114 is illustrated. Controlling process 114 communicates to application process 104 through control endpoint 302 that serves as an endpoint for sending and receiving data across inter-process connection 304. A fork operation is performed according to method 200 with the result shown on the right side of FIG. 3. The fork operation causes a duplication of the application process 104 to produce a copy, e.g., the child process 308, of the application process 104, e.g., the parent process. In the case of method 200, what distinguishes the scenario in FIG. 4 from what is currently done is that application process 104 is a component-based multithreaded program and that a second control endpoint 310 is created for the child process 308.

The presented method 200 for performing a fork operation on a multithreaded application supports in-memory checkpointing. In order to perform in-memory checkpointing, each thread of the multiple threads of the parent process saves its state information to memory prior to duplicating the parent process. State information is thus preserved in memory at the instruction that the fork operation is performed. State information is information needed to execute a thread which may include data stored in program counters or registers, for example. Execution of the parent process is suspended while the child process is executed. When the child process finishes execution, the child process can be discarded, e.g., deleted, from memory. The multiple threads of the parent process are restored using the saved state information of each of the multiple threads, and execution of the parent process resumes.

In computer processors, branch instructions are used to support if-then else control flow that is common in programming languages. Modern processors use speculative execution with branch prediction to increase efficiency. Speculative execution uses branch prediction to predict which instructions will be needed in the near future. When a branch that is expected to be taken is actually not taken (and vice versa), the processor is forced to flush the pipeline, e.g., the current thread that is executing, and potentially rollback other speculative executions. The debugging entity may desire to test each of these test scenarios. To achieve this, a dynamic random test generation and validation tool that can create random test stimulus is useful, as the tool can get the full architectural state of the processor through interactions with a simulator. To support these verification efforts, the tool needs to be able to generate instructions on both taken and not taken branches with the architectural states being preserved, which in turn necessitates that the simulator supports memory checkpointing. The described method can be used then to perform the fork operation prior to the branch instruction.

Although the subject matter has been described in language specific to structural features and/or acts, it is to be understood that the subject matter defined in the appended claims is not necessarily limited to the specific features or acts described above. Rather, the specific features and acts described above are disclosed as examples, implementing the claims and other equivalent features and acts; they are intended to be within the scope of the claims.

What is claimed is:

1. A computer implemented method comprising:
executing a component-based code including a set of instructions comprising multiple threads, wherein at least one component of the component-based code maintains one or more of the multiple threads, and wherein the component-based code is controlled by a controlling process on a computing system;
receiving a request from the controlling process to perform a fork operation on the component-based code at an instruction within the component-based code; and
directing the fork operation on the component-based code at the instruction by:
causing the component-based code to execute only one primary thread of the multiple threads by stopping execution of the other multiple threads,
duplicating the component-based code at the instruction to create a child process comprising a copy of the primary thread,
restarting execution of the other multiple threads in the component-based code,
performing a correction on the child process, and
creating multiple threads of the child process, wherein the created multiple threads of the child process mirror the multiple threads of the component-based code.

2. The computer implemented method of claim 1, wherein causing the component-based code to execute only one primary thread of the multiple threads by stopping execution of the other multiple threads includes:
sending a first callback function by the primary thread to all components of the component-based code to stop execution of the one or more multiple threads that the at least one component maintains.

3. The computer implemented method of claim 2, wherein the primary thread comprises a central scheduler of the component-based code.

4. The computer implemented method of claim 3, wherein the first callback function is sent by the central scheduler of the component-based code via a broadcast mechanism.

5. The computer implemented method of claim 1, wherein duplicating the component-based code at the instruction is performed by a fork function call of an operating system of the computing system.

6. The computer implemented method of claim 1, wherein performing a correction on the child process before starting execution of the multiple threads of the child process comprises recreating synchronization primitives of the child process.

7. The computer implemented method of claim 6, wherein the synchronization primitives are mutexes and condition variables.

8. The computer implemented method of claim 1, wherein restarting execution of the other multiple threads in the component-based code includes sending a second callback function by the primary thread to all components of the component-based code to start execution of the one or more multiple threads that the at least one component maintains.

9. The computer implemented method of claim 1, wherein creating multiple threads of the child process includes sending a third callback function by the copy of the primary thread to all components of the child process to start execution of the created multiple threads that the at least one component maintains.

10. The computer implemented method of claim 1, wherein the request from the controlling process is received by the component-based code via a first control endpoint in the controlling process, and further comprising duplicating, by the controlling process, the first control endpoint to create a second control endpoint for the child process.

11. The computer implemented method of claim 10, further comprising duplicating, by the controlling process, meta information of the component-based code from the first control endpoint to the second control endpoint.

12. The computer implemented method of claim 10, further comprising prior to duplicating the component-based code at the instruction, saving state information of each of the other multiple threads to memory.

13. The computer implemented method of claim 10, wherein the child process is terminated and deleted from memory by the controlling process via the second control endpoint.

14. The computer implemented method of claim 13, wherein the child process is terminated without executing a standard shutdown sequence.

15. The computer implemented method of claim 1, wherein the component-based code is simulator code of a computer system simulator.

16. The computer implemented method of claim 1, wherein the controlling process is a debug process of a debugger.

17. The computer implemented method of claim 1, wherein the controlling process is a validation tool process which includes a branch instruction, and wherein the fork operation is requested prior to the branch instruction.

18. The computer implemented method of claim 1, further comprising:
saving state information prior to duplicating the component-based code at the instruction;
duplicating, by the controlling process, the first control endpoint to create a second control endpoint for the child process;
resuming execution with the child process;
when the child process finishes execution:
discarding the child process, and
resuming execution of the component-based code at the instruction.

19. A computer-readable storage medium having instructions stored thereon for a computer system that when executed by a host computing system directs the host computing system to:
execute a component-based code including a set of instructions comprising multiple threads, wherein at least one component of the component-based code maintains one or more of the multiple threads, and wherein the component-based code is controlled by a controlling process on the host computing system;
receive a request from the controlling process to perform a fork operation on the component-based code at an instruction within the component-based code; and
direct the fork operation on the component-based code at the instruction by:
causing the component-based code to execute only one primary thread of the multiple threads by stopping execution of the other multiple threads,
duplicating the component-based code at the instruction to create a child process comprising a copy of the primary thread,
restarting execution of the other multiple threads in the component-based code,
performing a correction on the child process, and
creating multiple threads of the child process, wherein the created multiple threads of the child process mirror the multiple threads of the component-based code.

20. A computing system, comprising:
one or more processors; and
a memory,
wherein the memory stores instructions that when executed by the computing system:
execute a component-based code including a set of instructions comprising multiple threads, wherein at least one component of the component-based code maintains one or more of the multiple threads, and wherein the component-based code is controlled by a controlling process on the computing system;
receive a request from the controlling process to perform a fork operation on the component-based code at an instruction within the component-based code; and
direct the fork operation on the component-based code at the instruction by:
causing the component-based code to execute only one primary thread of the multiple threads by stopping execution of the other multiple threads,
duplicating the component-based code at the instruction to create a child process comprising a copy of the primary thread,
restarting execution of the other multiple threads in the component-based code,
performing a correction on the child process, and
creating multiple threads of the child process, wherein the created multiple threads of the child process mirror the multiple threads of the component-based code.
